(19) United States
(12) Patent Application Publication
(10) Pub. No.: US 2011/0102957 A1
(43) Pub. Date: May 5, 2011

(54) Protection Device

(75) Inventor: Norbert Kasper, Detmold (DE)

(73) Assignee: WEIDMUELLER INTERFACE GMBH & CO. KG, Detmold (DE)

(21) Appl. No.: 12/934,937

(22) PCT Filed: Mar. 25, 2009
(86) PCT No.: PCT/EP2009/053507

§ 371 Date: Dec. 2, 2010

(30) Foreign Application Priority Data
Mar. 31, 2008 (DE) 10 2008 016 585.9

(51) Int. Cl. H02H 9/04

(52) U.S. Cl. 361/91.5

(57) ABSTRACT

An overvoltage protection circuit is provided for protecting a load against overload damage, including a gross protection device for dissipating the major portion of the energy of the trouble event, a plurality of fine protection devices for limiting the remaining portion of the trouble energy to a safe value, and a diagnostic arrangement for determining the operating condition of the destructible gross and fine protection devices. A trouble event identifying arrangement compares with a reference voltage standard the residual output voltage existing between a pair of output terminals of the circuit, and a display arrangement indicates whether or not this residual output voltage meets the reference voltage standard.

### REFERENCE TO RELATED APPLICATIONS

This application is a continuation application of International Application No. WO 2009/121770, based on PCT Application No. PCT/EP2009/053507, which claims priority of German Application No. 10 2008 016 585.9 filed Mar. 31, 2008. This application is also related to the inventor's companion U.S. application Ser. No. ______ filed ______ [Attorney's Docket No. 50040].

### BACKGROUND OF THE INVENTION

1. Field of the Invention

An overvoltage protection circuit is provided for protecting a load against overload damage, including a gross protection device for dissipating the major portion of the energy of the trouble event, a plurality of fine protection devices for limiting the remaining portion of the trouble energy to a safe value, and a diagnostic arrangement for determining the operating condition of the destructible gross and fine protection devices.

2. Description of Related Art

This invention relates to a protective device for the protection of an electrical system. This kind of protective device protects an electrical system against impairment and/or destruction by a trouble event.

A trouble event is understood to be an event whose occurrence impacts an electrical system with electrical energy specifically in such a way that the electrical system will be impaired or destroyed in terms of its proper function. Example of trouble events are lightning strikes or static discharges, as a result of which, overvoltage pulses and/or over current pulses will be injected into the electrical system, for example, galvanically, inductively or capacitively, thus impairing or destroying the function of that system.

The structure and function of the above protective devices for electrical systems are familiar to the expert; therefore, no further explanation is required in the context of this invention.

There is, however, one disadvantage in the known protective devices: They require a comparatively great effort in terms of monitoring, testing and/or maintenance. This effort is particularly great when working with complex, for example, multiphase, protective devices. The present invention was developed to create a protective device that will eliminate the described disadvantages.

### SUMMARY OF THE INVENTION

Accordingly, a primary object of the invention is to provide an overvoltage protection circuit for protecting a load against overload damage resulting from lightning, a voltage surge or the like, including a gross protection device for dissipating the major portion of the energy of the trouble event, a plurality of fine protection devices for limiting the remaining portion of the trouble energy to a safe value, and a diagnostic arrangement for determining the operating condition of the destructible gross and fine protection devices. A trouble event identifying arrangement compares with a reference voltage standard the residual output voltage existing between a pair of output terminals of the circuit, and display means indicate whether or not this residual output voltage meets the reference voltage standard.

According to a more specific object of the invention, the protection circuit includes at least three lines having input terminals respectively connected with a source of electrical power, and output terminals connected with the load, a gross protection device connected between the first and second lines for dissipating the major portion of the energy of the trouble event, and the fine protection devices connected between the third and first lines and between the third and second lines of limiting to a safe degree the remaining portion of the trouble event energy. A diagnostic arrangement determines the operating condition of the gross protection device and the fine protection devices, including a trouble event identifying arrangement that compares with a reference voltage standard the residual output voltage existing between said first and second output terminals. A display device indicates whether or not the residual output voltage meets the voltage standard.

According to the invention, a protective device with a number of protective elements, for example, gas takeoff devices, varistors, suppressor diodes and possibly other devices, is monitored/tested with a diagnosis unit specifically in such a way that this monitoring will test the entire protective device so that monitoring/testing of the individual protective elements will no longer be required.

Advantageously, one can thus reduce the effort involved in monitoring, testing and/or maintaining these kinds of protective devices.

### BRIEF DESCRIPTION OF THE DRAWINGS

Other objects and advantages of the invention will become apparent from a study of the following specification, when viewed in the light of the accompanying drawing, in which:

FIG. 1 is a circuit diagram illustrating the inventive protective device in the form of an electrical circuit, and

FIG. 2 is a diagram of a voltage curve for illustrating the operation of the present invention.

### DETAILED DESCRIPTION OF THE INVENTION

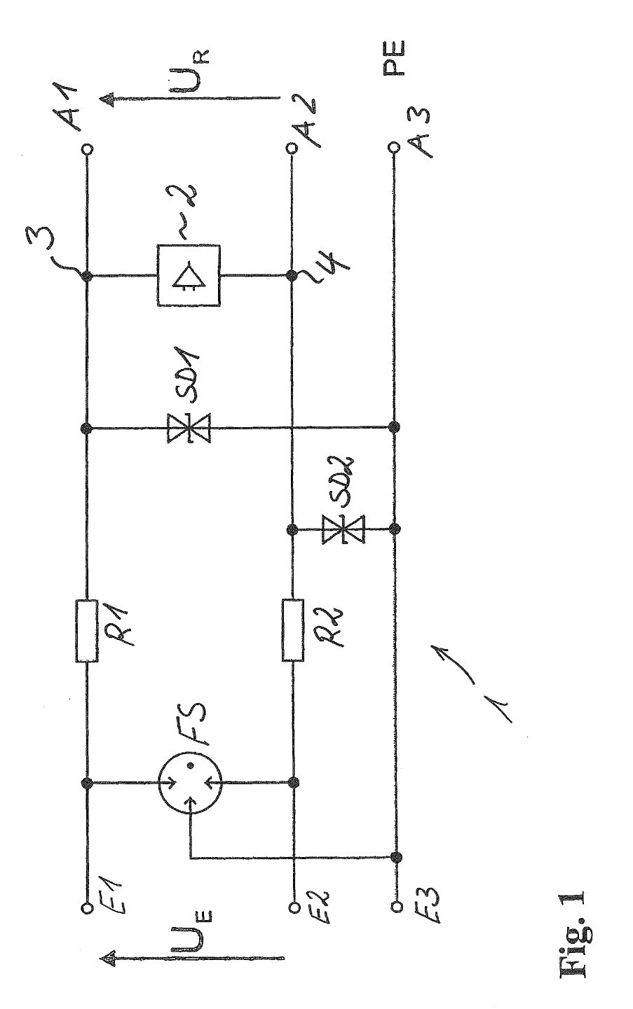

Referring first more particularly to FIG. 1, the protective circuit 1 of the present invention includes three lines L1, L2, L3 having input terminals E1, E2, E3, respectively, connected with the electrical power source 20, and output terminals A1, A2, A3, respectively, connected with the load 22 (for example, a test amplifier, or an industrial printed circuit). A major proactive device FS includes a gas-filled housing containing means defining a first spark gap between the third line L3 and the first line L1 lines, and a second spark gap between the third line L3 and the second L2. This part of the protective device is referred to as gross protection and “destroys” or dissipates most of the energy injected into the protective device 1 by a trouble event.

The remaining part of protective device 1 is referred to as fine protection and is used primarily to limit the occurring voltages to a degree that is not dangerous to the electrical system that is to be protected. An input terminal E1 is connected via a resistance R1 with an output terminal A1. A suppressor diode SD1 is connected in parallel across the output terminals A1 and A3, a PE biasing potential being applied to the output terminal A3 by the source 16. Similarly, input terminal E2 is connected via a resistance R2 with output terminal A2, and a suppressor diode SD2 is connected in parallel across the output terminals A2 and A3.

The number of protective phases—in other words, gross and fine protection—is not limited to two phases; furthermore, the number of above-described branches is not limited to two. This structure is to be understood merely as exemplary and, depending on the practical case of application, it can turn out differently and it can be expanded/modified without leaving the coverage of this invention.

An electrical load 22, for example, a test amplifier or an industrial PC, which is to be protected against damage by trouble events, is connected with the protection circuit via the output terminals A1 to A3. Input terminals E1-E3, depending on the practical use, in turn, are connected with signal sources and/or with devices that supply electrical energy, for example, an electrical power source 20.

In each case, the protective device 1 and the electrical system 22 that is to be protected are so installed and wired that in case of a trouble event, any injected electrical energy will be injected on the input side of protective device 1. An expert skilled in the art is well familiar with this.

In case of a trouble event, electrical energy is injected into protective circuit 1. As a result of this injection, there will be currents as a result of protective elements, in this case, specifically the parts that are illustrated and labeled FS, SD1 and SD2, and they can cause the destruction of these protective elements if these currents are above the values that are permissible for the particular element. Such values can involve the duration and/or the value of a current.

According to the invention, protective circuit 1 includes a diagnosis means 2 shown in the form of a diagram for the purpose of identifying the functional state of protective device 1, whereby diagnosis unit 2 includes trouble event identification means 12 for identifying trouble events, and measurement means 10, for the acquisition of voltage curves between a first measurement point and a second measurement point. In the exemplary embodiment described, the first measurement point 3 is located electrically on line L1 at the potential of the output terminal A1, and the second measurement point 4 is located electrically on line L2 at the potential of output terminal A2. The voltage that is recorded between these two measurement points or the voltage curve, thus acquired, will hereafter be referred to as the residual voltage—see the voltage arrow U_{R}.

The measurement means 10 acquires/measures the voltage curve continually at certain time intervals and/or at specified moments, as determined by time interval means 26. With the help of the reference voltage values of the voltage curve acquired by the measurement means 10, the trouble event identification means 12 recognizes a trouble event on the basis of predetermined features, for example, on the basis of a certain voltage gradient, a certain voltage value and/or a certain voltage value range.

The above-specified features are predetermined and fixed as a function of the protective elements used (FS, SD1, SD2). Furthermore, the features on whose basis a trouble event is identified can be provided with time markers. In this way, to identify a trouble event by means of the trouble event identification device, it may be required that a certain gradient, a certain voltage value, or a certain voltage value range must be identified for a certain span of time so that the trouble event identification device will recognize a trouble event. This time frame can also depend on the used protective elements (FS, SD1, SD2).

If the trouble event identification device has identified a trouble event, then the measurement means 10, which for this purpose is equipped with the required means, will check whether the voltage curve can meet a number of predetermined criteria. If the voltage curve meets the number of predetermined criteria, then the diagnosis identification device 2 recognizes the functional state of protective device 1 as being functionally operative; if the voltage curve does not meet the number of predetermined criteria, then the diagnosis identification device 2 recognizes the functional state of protective device 1 as being not functionally operative.

The number of predetermined criteria can include a wide variety of individual criteria. The latter again can involve gradients, voltage values and voltage value ranges and can depend on the protective elements that are used and/or the electrical system that is to be protected.

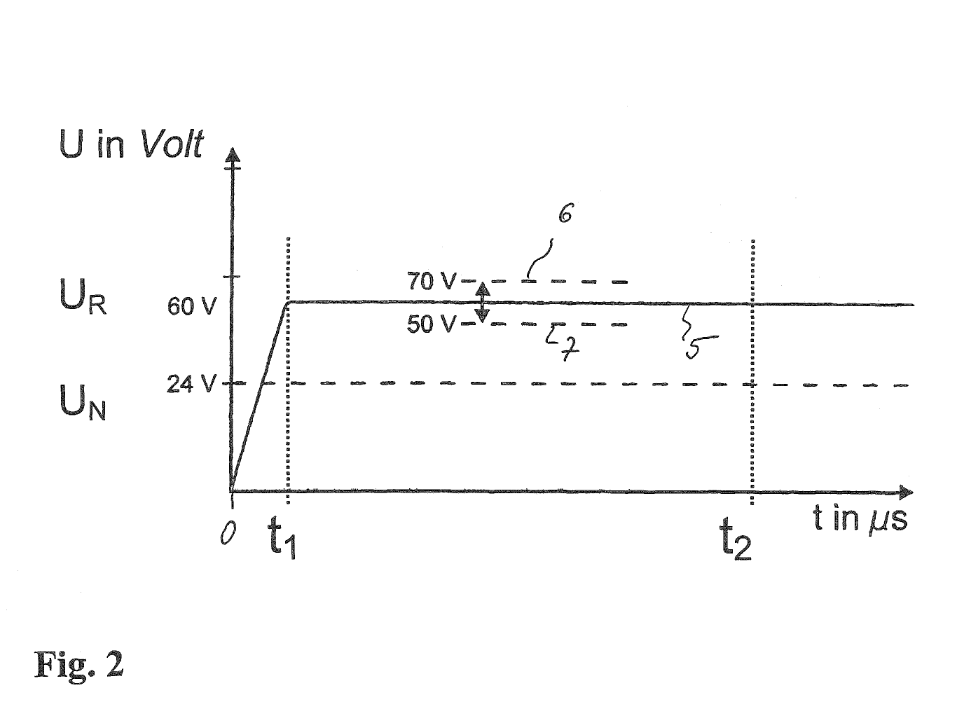

FIG. 2, by way of example, shows a voltage curve that is acquired by the measurement device between two measurement points 3, 4. On the basis of the illustrated exemplary voltage curve, the invention will be explained particularly in terms of the criterion involving a voltage value range.

The voltage curve is illustrated in a coordinate system, whereby the horizontal axis (t in μS) represents the time axis, and the vertical axis (U in volt) represents the voltage axis.

The voltage curve 5, illustrated by a flat line in the area of 0 second up to moment t₁, has a steeply rising curve and at moment t₁ passes into a horizontal curve essentially parallel to the time axis, which also still prevails at moment t₂.

Also illustrated by means of a broken line is a nominal voltage (U_{N}=24 V), for example, a distribution voltage supplied between the input terminals E2 and E1 in FIG. 1 for the electrical system that is to be protected, whereby the monitoring voltage in FIG. 1 is labeled with arrow U_{E}.

By way of example, furthermore, there is illustrated an upper voltage value 6 (here, by way of example, 70 volts) and a lower voltage value 7 (here 50 volts). To meet a criterion concerning this particular voltage value range, the voltage curve must lie between these two voltage values. The illustrated voltage curve meets this criterion, as one can see in FIG. 2 (U_{R}=60 V). In this case, the diagnosis unit identifies the functional state of the protective device as being functionally operable.

Furthermore, to recognize a state of functional operability, one may require a criterion involving a certain span of time, for example, it may be required that a specific voltage value be complied with for a certain span of time (t₂=t₁), as shown in FIG. 2, or it may be required that a voltage curve may extend at most for a certain span of time in a specific voltage value range.

Furthermore, it may be desirable to design the measurement device such that the measurements that are done to acquire the voltage curve are performed by time interval means 24 at predetermined time intervals, for example, every 10 milliseconds, and/or the measurements are done at certain specified moments.

If diagnosis unit 2 identifies a predetermined functional state, then this state can be displayed by a display unit, for example, a light-emitting diode or via a messaging unit, for example, a bi-stable relay with a connected contact, and/or can be further reported for further processing to additional, possibly superordinate electrical devices.

The invention is not confined to the described exemplary embodiments, which can be modified in many different ways. In particular, it is possible to execute the mentioned features in combinations other than those mentioned.

To recognize a functional state or a trouble event, it is furthermore also conceivable to use currents or current curves and to monitor them in an analogous fashion with respect to the described voltages and/or voltage curves.

While in accordance with the provisions of the Patent Statutes the preferred forms and embodiments of the invention have been illustrated and described, it will be apparent to those skilled in the art that changes may be made without deviating from the invention described above.

1. Protective device (1) with at least one protective element (FS, SD1, SD2) for the protection of an electrical system against impairment and/or destruction by a trouble event, characterized in that
a. protective device (1) has a diagnosis device (2) for functional state identification of protective device (1) with a measurement device and a trouble event identification device.
b. whereby the measurement device is so designed as to acquire a voltage curve between a first and a second measurement point (3, 4) and whereby the measurement device, when the trouble event identification device recognizes a trouble event on the basis of a number of predetermined features, is so designed as to test whether the voltage curve meets a number of predetermined criteria in such a way that protective device (1) is recognized by diagnosis device (2) as being functionally operable when the voltage curve acquired by the measurement device meets the number of predetermined criteria and in such a way that protective device (1) is identified by diagnosis device (2) as not being functionally operable when the voltage curve acquired by the measurement unit does not meet the number of predetermined criteria.

2. Protective device (1) according to claim 1, characterized in that [missing text in original] has a feature involving a number of predetermined features with at least one predetermined gradient of the voltage curve and/or a feature relating to a predetermined voltage value of the voltage curve and/or a predetermined voltage value range of the voltage curve [sic].

3. Protective device (1) according to one of the above claims, characterized in that the number of predetermined criteria has at least one criterion defining a voltage value range.

4. Protective device (1) according to claim 3, characterized in that the voltage value range has a predetermined lower voltage value (7) and a predetermined upper voltage value (6).

5. Protective device (1) according to claim 7, characterized in that the lower voltage value (7) amounts to 50 volts and that the upper voltage value (6) amounts to 70 volts.

6. Protective device (1) according to one of the above claims, characterized in that the features and criteria are tied in with requirements concerning predeterminable moments and/or time intervals.

7. Protective device (1) according to one of the above claims, characterized in that the predeterminable features, criteria and/or requirements are predetermined as a function of the protective element or elements used.

8. Protective device (1) according to one of the above claims, characterized in that the measurements performed by the measurement device are executed at predetermined time intervals and/or at predeterminable moments.

9. Protective device (1) according to one of the above claims, characterized in that protective device (1) has a display unit for the purpose of displaying the functional state identified by diagnosis device (2).

10. Protective device (1) according to one of the above claims, characterized in that protective device (1) has a messaging unit for the further reporting of the functional state identified by diagnosis device (2).

11. Process for the operation of a protective device (1) according to one of the above claims, where
a. the measurement device acquires a voltage curve between a first and a second measurement point (3, 4) and the measurement device, when the trouble event identification device on the basis of a number of predetermined features recognizes a trouble event, tests to see whether the voltage curve meets a number of predetermined criteria, and
b. whereby protective device (1) is identified by diagnosis device (2) as being functionally operable when the voltage curve acquired by the measurement device meets a number of predetermined criteria and whereby protective device (1) is identified by diagnosis device (2) as not being functionally operable when the voltage curve acquired by the measurement device does not meet the number of predetermined criteria.
